(19) United States
(12) Patent Application Publication
(10) Pub. No.: US 2012/0047162 A1
(43) Pub. Date: Feb. 23, 2012

(54) Method and System for Securing Academic ERP Database using Datasource Proxy

(75) Inventors: Christopher Guglietti, Brookline, MA (US); Youyu Shao, Newton, MA (US); Avi Neer, Framingham, MA (US)

(73) Assignee: JENZABAR, INC., Boston, MA (US)

(21) Appl. No.: 12/860,219

(22) Filed: Aug. 20, 2010

(51) Int. Cl. G06F 17/30; H04L 9/32

(52) U.S. Cl. 707/769; 726/4; 707/E17.014

(57) ABSTRACT

A secured academic ERP system comprises an ERP database storing data for an academic institution, an application server for authenticating users and generating requests to access the ERP database for the users, a security system that accesses a user permissions table that maps the users to permitted organizations within an academic institution and modifying the requests to limit the requests to the permitted organizations for the users making the requests, and a datasource for receiving the modified requests and passing those requests to the ERP database. This system extends security beyond the traditional role-based data security model to support the finer granularity security at the level of the content. This is achieved without the need for a new database architecture or the use of separate databases for different organizations

### BACKGROUND OF THE INVENTION

Academic enterprise resource planning (ERP) systems are used to manage backoffice information at universities, colleges, and other academic institutions. The types of data managed by these systems generally fall into two categories: student information and business information.

The student information in the academic ERP systems is often managed by a number of components. The admissions components of ERP systems are used to manage student admissions, from identifying and recruiting candidates to automating the admissions processes by tracking prospects, importing student data, and analyzing and generating candidate information reports. They are used to manage admissions communications, organize candidate information, schedule recruiting visits and interviews, manage recruitment data, and track students from admissions to registration. Financial aid components of the ERP systems often have the ability to generate financial aid packages and awards, process disbursements and adjustments, process work-study funds, track academic progress, enable authorized administrators to view financial aid data, and facilitate compliance with federal guidelines. Registration components of the systems manage enrollment data and course registration, generate catalogs, determine space availability, course conflicts, course pre-requisites, and non-course pre-requisites. Additional components are often available that cover student life such as student activities, residence assignment, violations and sanctions, advising, and alumni development and advancement activities.

The business information in the academic ERP systems is often managed by a number of other components. Accounts payable components typically provide vendor profiles and generate annual vendor reports, invoices and purchase orders. General ledger components cover automated billing, manage payment plans and manage in-house loans. The components also automate the budgeting process, enable the management of fixed assets, and cover payroll and personnel and other human resource (HR) functions.

Because these academic ERP systems centralize so much of the institutions' data, security is a critical issue. Current systems use a traditional role-based data security model. The security controls access to tables and columns within those tables within the ERP system. For example, to illustrate a few examples, instructors at the institution might be granted access to registration information for students but not necessarily financial aid information for those same students. In contrast, financial aid administrators will have access to financial aid information for the students but possibly not those student's grades. Healthcare professionals will have access to sensitive student personal data but not student grades or registration information, for example.

From an architecture standpoint, some of the most successful academic ERP systems use a single database to handle the entire institution's ERP data. This centralization in a single database provides needed access for administrators to data for the entire institution. Budgets for individual departments can be rolled up to a single institutional budget. Student enrollment can be managed across departments and other divisions within the institution seamlessly. Purchasing can be performed for the entire institution in the most cost-effective manner.

### SUMMARY OF THE INVENTION

Many academic institutions, especially larger universities, can have complex organization hierarchies. A single institution may have multiple divisions, such as separate colleges and/or schools. For example a university may have a college of arts and sciences, a college of engineering, and different schools for business, education and nursing, to list a few examples. Graduate schools may also be included such as medicine, law and graduate arts and sciences.

Within the separate divisions, there may be different departments. For example the college of arts and sciences may have departments associated with different foreign languages, mathematics, physics, literature, etc. The college of engineering may have different departments for each of the engineering disciplines. In summary, each academic institution will generally have a complex organizational hierarchy that will be unique to that institution.

Especially in these larger academic institutions, the traditional role-based data security model may not provide adequate security segmentation among the various organizations, such as divisions and the departments within those divisions. Departmental level administrators should have access to records that are specific to that department or possibly the division, but not the entire institution, on one hand. Division level administrators generally should have access to all information within that division but not institutional level access. It may be important to limit instructors to have access only to information within their department or division but possibly not for the entire institution, except possibly for instructors that head divisions or departments. In contrast, many of the institutional level administrators require access to all divisions and departments within those divisions in order to perform their tasks. Part of the need for this segmentation is also driven by the highly political nature of academic institutions. There are concerns regarding student and faculty poaching between divisions or departments.

One solution to segmenting security is to modify the database system to support the finer granularity security. There are problems with this approach, however. First it requires a new database architecture. This may not be desirable, however, since new products must be created for the different types of institutions. It also creates legacy issues since institutions must completely update their database system to implement the finer granularity security.

Another solution is to use separate databases for different organizations, such as for each division or each department. This, however, undermines the advantages of having a single database for the entire institution in terms of enabling the centralized management of that entire institution since now additional systems are required to roll-up data from across organizations.

In general, according to one aspect, the invention features a method for securing an academic ERP database. The method comprises intercepting requests to access the ERP database and accessing a user permissions table that maps users to permitted organizations within an academic institution. The requests are modified to limit the requests to the permitted organizations based on the permissions of the users making the requests and the modified requests are passed to the ERP database. Example organizations within the academic institution include divisions and departments within the divisions.

In a current embodiment, the requests are received from an application server. The requests include queries or updates for the ERP database. A security definitions source is accessed for a secured table included in the request. This source's subquery is used to generate the modified requests for both divisions and departments.

Preferably, a user permissions table is provided that lists users and the permitted organizations and categories for each of the users. Further, the security definitions source comprises XML files, with each file being used to secure an entity within the ERP database and the modified requests are passed to a JDBC datasource, which accesses the ERP database.

In general according to another aspect, the invention features a secured academic ERP system. The system comprises an ERP database storing data for an academic institution and an application server for authenticating users and generating requests to access the ERP database for the users. A security system accesses a user permissions table that maps the users to permitted organizations within an academic institution and modifies the requests to limit the requests to the permitted organizations for the users making the requests. A datasource receives the modified requests and passes those requests to the ERP database.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating a hierarchy of organizations within an academic institution and how permissions for users is limited among those organizations according to the present invention;

FIG. 2 is a block diagram showing an academic ERP system and a content level security system for implementing user permissions within the ERP database; and

FIG. 3 is a flow diagram illustrating the operation of the content level security system according to an embodiment of the present invention.

### DETAILED DESCRIPTION OF THE PREFERRED EMBODIMENTS

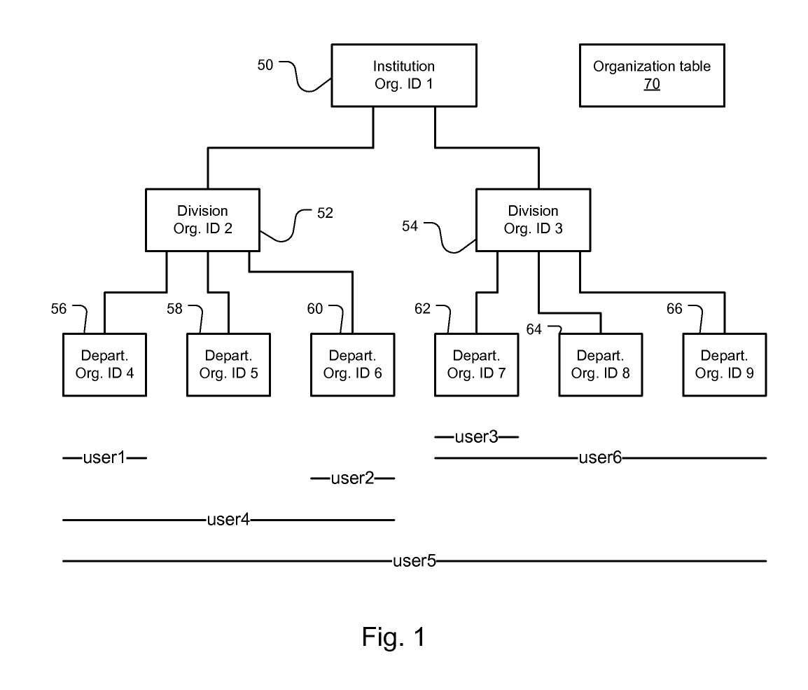

FIG. 1 illustrates the hierarchical organization of an academic institution and the content level security provided by the present system.

In the example, there are three levels of organizational hierarchy. The three organization types are: institute, divisions, and departments. In the typical example, the institute 50 is the academic institution such as a college or university. In the current implementation, there is only one top level organization. Then, there are one or more divisions 52, 54 within the institution 50. The parent organization, top level type is the institute 50, which is identified as Org. ID1 in an organization table 70; when creating a new division, the top level organization will be automatically assigned to the parent organization. Examples of divisions are colleges or schools within the institution.

Each of the divisions (Org. ID 2, 3) 52, 54 has one or more departments. For example, division 52 has three departments (Org. ID 4, 5, 6) 56, 58, 60. Division 54 similarly has three departments (Org. ID 7, 8, 9) 62, 64, 66. The organization type department is the third level organization. The parent organization type will be one of divisions. Examples of departments are departments for foreign languages and English literature in a college of arts and sciences division.

In the current embodiment, the hierarchy of the organization 50 is stored in the organization table 70. The organization table 70 uses a recursive design, so the entire organizational hierarchy of the institution 50 is defined in one table. This means each row has a parent id referencing another row in the same table.

According to the preferred embodiment, different users then have different access to data associated with each of these divisions and departments within the divisions. For example, user1 has access only to data associated with the department (Org. ID 4) 56; and user2 has access only to data associated with department (Org. ID 6) 60. Other users such as user4 has access to the data associated with division (Org. ID 2) 52 inclusive of its three departments; user6 has access to all of the data associated with division (Org. ID 3) 54 including its departments. Finally, some users, user5, have access to all the data of the institution (Org. ID 1) 50.

This content level security is implemented despite the fact that a single database is used to hold the data for the institution 50. Moreover, this database itself need not have any provisions for implementing security associated with the different divisions and different departments and particularly segmenting access of different users among the divisions and departments.

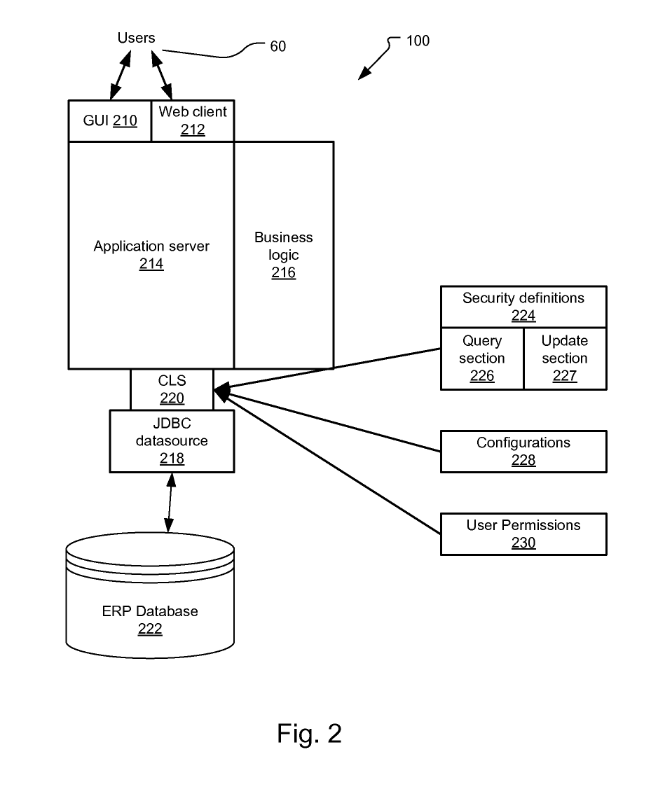

FIG. 2 is a block diagram showing the framework stack for an ERP system 100 that provides content level security according to the principles of the present invention.

Users 60 access the system 100 via a graphical user interface 210 or a web client 212 in the current embodiment. Typically, the graphical user interface 210 is installed on client computers within the institution and allows the users 60 to access the application server 214. In the illustrated example, a web client 212 is also provided to allow the users 60 access the application server 214 using any browser. This facilitates remote access and access from client computers that have not been preconfigured.

The application server 214 manages user authentication and functions as a gateway to the system 100. The primary role of the application server is to host business processes which in aggregate define the ERP system. The application server preferably hosts additional services, such as webservices, email gateway and a task scheduler.

The application server accesses a business logic unit 216, which specifies the intelligence and rules that implement the ERP system 100. It specifies the student information systems and the components including the management of the admissions, processes financial aid, registration, student life, alumni development, and advancement activities components. It also specifies the business information systems including the accounts payable, general ledger, budgeting, asset management, payroll, and human resource components.

The institution's data reside in the ERP database 222. The application server 214 accesses the ERP database 222 via a data source 218 that handles the queries and updates to the database 222.

In the current embodiment, the data source 218 is a Java database connectivity (JDBC) engine, which is an industry standard for database-independent connectivity between the Java programming language and databases. It provides an application programming interface for standard query language (SQL) database access.

Between the application server 214 and the data source 218 is the content level security system 220. This system intercepts queries into the data source 218 and reformats those queries in order to implement security within the ERP database 222.

In a specific example, the security system 220 implements row-level security by reformatting queries to narrow those queries in response to the user permissions. For instructions to update the ERP database, the security system 220 implements row-level security by verifying the modified record is within the scope of records the user has permission to modify. In effect, the security system 220 functions as a proxy for the queries and database updates into the data source 218 for the application server 214. In that proxy process, the queries are narrowed based on the permissions associated with the user generating the queries and then the modified queries are passed to the datasource 218.

The security system 220 receives two types of data from the applications server: 1) the user generating the query or update; and the 2) query or update themselves. The security system 220 in turn accesses three sets of metadata in order to implement the content level security: security definitions files 224, configurations files 228, and user permissions files 230.

In the preferred embodiment, the security definition files 224 are XML files. Each file is used to secure a single entity within the system 100. An entity is a business object that maps to a single table in the ERP database 222. All of these security definitions have a direct or indirect link to the different divisions within the institution 50. Each security definition file 224 is divided into a query section 226 and an update section 227.

In the current embodiment, there are a number of tables in the ERP database 222 that are secured by the content level security system 220. A hierarchy of tables is used to define a course. The information in these tables ranges from general to specific. These tables include:

TABLE I

| Table | Definition |
|---|---|
| Course | The course table is at the base of the hierarchy |
| | holding the common information about a course. |
| Offering | The offering table is the next level in the course |
| | definition hierarchy adding more specific |
| | information about a course to be offered. |
| OfferingType | The offering type table is a reference table defining |
| | to types of offerings that can be used in the system. |
| PreferenceDef | Definition table to define student registration |
| | preference questions |
| RegistrationDef | Data table to define student registration preference |
| | answers |
| Section | The section table is the next level below offering in |
| | the course definition hierarchy adding more specific |
| | information about dates and times a course to be |
| | offered. |
| DiscountProgram | Definitions of discounts will be which will be |
| | offered on courses. |
| Financial | Definition of financial transaction which will be |
| | posted when a course is purchased. |
| Product | Holds product information for products which will |
| | be sold through the system. |
| CreditMemo | Adjustments to financial transactions. |
| Ord | Captures information about an order placed in the |
| | system. |
| OrderItem | Detail information about an order placed in the |
| | system. |
| PaymentLine | Detail payment information about an order placed in |
| | the system. |
| ProductOrdLine | Detail information about a product order placed in |
| | the system. |
| SeatGroupOrdLine | Detail information about a seat group order placed |
| | in the system. The seat group table is the next level |
| | below section in the course definition hierarchy |
| | allowing a section to be split into different parts |
| | for pricing and marketing purposes. |
| ShippingOrdLine | Detail information about shipping for a product |
| | order placed in the system. |
| GLAccount | General ledger account definitions. |

The query section 226 handles all database reads to the ERP database 222. The query section contains a SQL subquery that is added to any query in the system that involves one of the secured tables or entities set forth in Table I. The SQL subquery provides a link to the organization table 70 that stores the hierarchy of the institution 50. The SQL subquery is added to the query during runtime by the security system 220. The list of permitted organizations for the user generating the query or update is provided dynamically by the security system 220 based on the permissions of the user who issued the query. These permissions are stored in the user permissions table 230.

In the current embodiment, there are two SQL subqueries in the query section 226: sub-query for division; and a sub-query for department. This is an example of a department sub-query for the NTM_Section.xml security definition:

```
  <template>
    <![CDATA[
    SELECT CLS_Section.*
    FROM NTM_Section CLS_Section INNER JOIN NTM_Offering
CLS_Offering ON (CLS_Section.OfferingID =
CLS_Offering.OfferingID AND
CLS_Offering.OrganizationID IN (${department}))
    ]]>
  </template>
```

For query operations the list of departments a user has permission to access is applied to the sub-query template contained in security definition to produce a narrowing sub-query. This narrowing sub-query replaces the respective table in the intercepted query.

The update section 227 handles all modifications to the ERP database 222 that include insert, update, and delete. The update section contains a query that will be used by the security system 220 associated with each table or entity. For each database operation, the security system 220 accesses the user permissions 230 for the user that is logged onto the system to determine whether that user has permissions to insert, update, or delete. The update section provides a list of permitted organizations within the institution during run time based on the permissions associated with the user.

There are two queries in the Update section: a query for division; and a query for department. This is an example of a department query for the NTM_Section.xml security definition

<template>
<![CDATA[
SELECT CLS_Offering.OfferingID
FROM NTM_Offering CLS_Offering
WHERE CLS_Offering.OfferingID = ${NTM_Section.OfferingID}
AND CLS_Offering.OrganizationID IN (${department})
]]>
</template>

For update operations the list of departments a user has permission to access is applied to the query template contained in security definition to produce a narrowing query. This narrowing query is used to determine if the user has update rights for the modified record in the intercepted update.

The security definitions 224 are grouped into categories as shown below:

### Data Categories—List of Secured Tables by Category

TABLE II

| Course Category | Financial Category | Organization Category |
|---|---|---|
| Course | DiscountProgram | Organization |
| Offering | Financial | |
| OfferingType | Product | |
| PreferenceDef | CreditMemo | |
| RegistrationDef | Ord | |
| Section | OrderItem | |
| | PaymentLine | |
| | ProductOrdLine | |
| | SeatGroupOrdLine | |
| | ShippingOrdLine | |
| | GLAccount | |

The configurations module 228 is used to configure the data source 218 to use the security system 220 for data sources that are secure as identified in Tables I and II.

The user permissions table 230 maps individual users to organizations within the institution 50 and data categories. As illustrated in the following exemplary User Permissions file, see Table III, clstest1 has access to division-4 and all categories of secured tables: course, financial, organization. In contrast, user clstest5 has access only to departments 5, 6, and 21 and is limited to tables under the course category.

User Permissions—Granted by Organization and Category

TABLE III

| UserID | Organization | Category |
|---|---|---|
| clstest1 | Division - 4 | All |
| clstest2 | Division - 3 | Course |
| clstest3 | Dept - 7, 8 | All |
| clstest4 | Dept - 17 | All |
| clstest5 | Dept - 5, 6, 21 | Course |
| clstest6 | Dept - 5, 6, 21 | Financial |

The categories are a configuration construct that provide a level of indirection between users and tables. Tables are organized or placed into categories. User permissions are granted to categories. This construct is included to ease the burden of permission setup and management. When a table is added to the database 222, it can be associated with a category and consequently inherit the permissions associated with the category. As a result the administrator does not have to grant each user permission to the new table. When adding a new user to the system, the user can be granted permission to a small number of categories rather than scores of tables.

The following shows an original query and a modified query using the example of clstest1 accessing the Section table:

```
Original
SELECT * FROM NTM_Section
Modified
SELECT *
FROM
  (SELECT CLS_Section.*
    FROM NTM_Section CLS_Section
    INNER JOIN NTM_Offering CLS_Offering ON
(CLS_Section.OfferingID = CLS_Offering.OfferingID)
    INNER JOIN NTM_Organization CLS_Dept ON
(CLS_Offering.OrganizationID = CLS_Dept.OrganizationID AND
(CLS_Dept.OrganizationID IN (4) OR
CLS_Dept.ParentOrganizationID IN (4)))
  ) NTM_Section
```

The original query is a simple select against the section table. Since this table is secured, the content level security system 220 replaces the table with a subquery and uses the original table name as an alias for the subquery so the remainder of the query is not impacted. The injected subquery narrows the section rows returned based on the organizations the user has access to. Since the section table is not directly related to organization, the offering table functions as an intermediary. In this example the user has access to division 4. So any section with a relationship to division 4 or departments within division 4 would be included in the subquery.

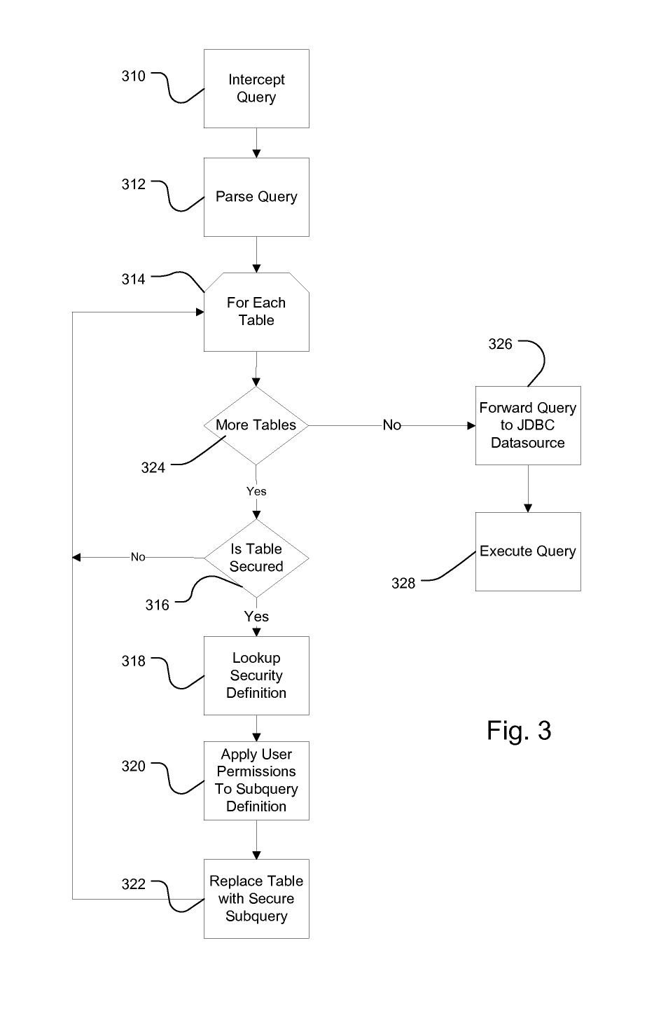

FIG. 3 is a flow diagram illustrating the operation of the content level security system 220. Queries from the application server 214 to the data source 218 are intercepted by the security system 220. The security system parses the queries in step 312. This parsing process determines the tables included in the queries and the query instructions.

In step 316, the security system determines whether the table in the query is secured by reference to the security definitions 224. If the table is not secure, then the parser increments to the next table to determine whether it is secured in steps 314 and 316.

In step 318, the security definition for the table is accessed from the security definitions file 224. Then in step 320, the permissions associated with the user issuing the query are accessed and the permissions are applied to the subquery definition obtained from security definitions file 224. In step 322, the table referenced in the query is replaced with the secure subquery. In step 324, it is determined whether there are any other tables in the query. This allows the secure subquery to be applied for each secured table in the query.

Finally, in step 326, the query is forwarded to the data source 218 and the data source then executes the query 226 against the ERP database 222.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for securing an academic ERP database, comprising:
intercepting requests to access the ERP database;
accessing a user permissions table that maps users to permitted organizations within an academic institution;
modifying the requests to limit the requests to the permitted organizations for the users making the requests; and
passing the modified requests to the ERP database.

2. A method as claimed in claim 1, wherein the requests are received from an application server.

3. A method as claimed in claim 1, wherein the requests include queries for the ERP database.

4. A method as claimed in claim 1, wherein the requests include updates for the ERP database.

5. A method as claimed in claim 1, wherein the user permissions table lists users and the permitted organizations for each of the users.

6. A method as claimed in claim 5, wherein the permitted organizations replaces tables in the requests to produce a narrowing sub-query

7. A method as claimed in claim 1, wherein the user permissions table lists users and the permitted categories for each of the users.

8. A method as claimed in claim 1, further comprising parsing the requests for tables of the ERP database that are secured.

9. A method as claimed in claim 1, further comprising accessing a security definitions source for a secured table included in the request, wherein the security definitions source specifies how the requests are modified based on the user permissions.

10. A method as claimed in claim 8, wherein the security definitions source contains a subquery that is used to generate the modified requests.

11. A method as claimed in claim 9, wherein the security definitions source comprises XML files, with each file being used to secure an entity within the ERP database.

12. A method as claimed in claim 1, wherein the organizations within the academic institution includes divisions and departments within the divisions.

13. A method as claimed in claim 12, further comprising accessing a security definitions source for a secured table included in the request, wherein the security definitions source contains a subquery that is used to generate the modified requests for both divisions and departments.

14. A method as claimed in claim 1, wherein the modified requests are passed to a JDBC datasource, which accesses the ERP database.

15. A secured academic ERP system, comprising:
an ERP database storing data for an academic institution;
an application server for authenticating users and generating requests to access the ERP database for the users;
a security system that accesses a user permissions table that maps the users to permitted organizations within an academic institution and modifies the requests to limit the requests to the permitted organizations for the users making the requests; and
a datasource for receiving the modified requests and passing those requests to the ERP database.

16. A system as claimed in claim 15, wherein the requests include queries for the ERP database.

17. A system as claimed in claim 15, wherein the requests include updates for the ERP database.

18. A system as claimed in claim 15, wherein the user permissions table lists users and the permitted organizations for each of the users.

19. A system as claimed in claim 15, wherein the user permissions table lists users and the permitted categories for each of the users.

20. A system as claimed in claim 15, wherein the security system parses the requests for tables of the ERP database that are secured.

21. A system as claimed in claim 15, further comprising a security definitions source, which is accessed by the security system, that specifies how the requests are modified based on the user permissions.

22. A system as claimed in claim 21, wherein the security definitions source contains a subquery that is used to generate the modified requests.

23. A system as claimed in claim 21, wherein the security definitions source comprises XML files, with each file being used to secure an entity within the ERP database.

24. A system as claimed in claim 15, wherein the organizations within the academic institution includes divisions and departments within the divisions.

25. A system as claimed in claim 15, wherein the datasource is a JDBC datasource.
